(19) United States
(12) Patent Application Publication
(10) Pub. No.: US 2007/0013157 A1
(43) Pub. Date: Jan. 18, 2007

(54) Dual hitch assembly

(76) Inventors: James W. Wiff, Cologne, MN (US); Paul D. Holtan, Savage, MN (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/184,095

(22) Filed: Jul. 18, 2005

(51) Int. Cl. B62B 1/00

(52) U.S. Cl. 280/47.131

(57) ABSTRACT

The present invention is a dual hitch assembly comprising a framework, a travel surface contacting assembly, and a biasing element. The framework includes a first hitch and a second hitch. The biasing element extends between the framework and the travel surface contacting assembly. The dual hitch assembly allows two wheeled carts to be coupled together in a train-like manner by placing the hitch assembly between the two carts and coupling the first hitch to the first cart and the second hitch to the second cart.

### FIELD OF THE INVENTION

The present invention relates to devices and methods for assisting in the transport of wheeled carts within a facility. More specifically, the present invention relates to devices and methods for coupling wheeled carts to each other.

### BACKGROUND OF THE INVENTION

Various industries use wheeled carts to move items between locations within a facility. For example, wheeled carts are used in hospitals to carry clean linen (sheets, towels, etc.) from the linen storage rooms to use locations on the patient floors. The carts are left at the use locations until the clean linen is used and the carts have been refilled with soiled linen. The full carts are then moved to the hospital laundry for washing or onto a truck for delivery to an off-site laundry facility. The soiled linen is removed from the carts, which are then washed, filled with clean linen and returned to the linen storage rooms. It is common for hospital employees to manually push/pull carts between locations within a hospital facility, having to travel up and down inclines and across concrete, tiled and carpeted floor surfaces.

The carts commonly weigh hundreds of pounds when fully loaded and have continued to increase in size over the years. Hospital facilities grow in size over time, which increases the distances employees must move the carts within the facilities. Often, many carts are delivered from the same starting location to the same destination. Efficiency requires, when possible, that an employee move two carts at a time between common locations. The significant weight of the carts, the need to move two carts at a time, and the ever increasing distances the carts must be moved have combined to significantly increase employee injuries associated with moving loaded carts.

To reduce the frequency of injuries associated with the movement of loaded carts, hospitals have begun to provide powered pulling machines for mechanizing the movement of the carts within a hospital facility. The PowerPal® 1000, as manufactured by Dane Industries, Inc. of 7105 Northland Terrace, Brooklyn Park, Minn. 55428, is an example of such a powered pulling machine. In use, a powered pulling machine is hitched to the side of a single cart and an employee steers the machine as the machine pulls the cart. Unfortunately, many carts do not have hitches that allow them to be hitchable to another cart, and it is often cost prohibitive to purchase new hitchable carts or retrofit existing carts to become hitchable. Consequently, powered pulling machines pull only a single cart during a trip between locations when efficiency requires that two or more carts be pulled during the trip. As a result, hospitals (and other various industries that use wheeled carts to move items between locations within a facility) must choose between employee safety and operational efficiency.

There is a need in the art for a hitch assembly that allows one cart to be hitched to another cart. There is also a need in the art for a method of hitching multiple carts together and transporting the carts within a facility.

### BRIEF SUMMARY OF THE INVENTION

The present invention, in one embodiment, is a hitch assembly comprising a framework, a travel surface contacting assembly, and a biasing element. The framework includes a first hitch and a second hitch. The biasing element extends between the framework and the travel surface contacting assembly.

In one embodiment, the biasing element is a gas shock. In one embodiment, the biasing element is a helical spring.

In one embodiment, the hitches are at generally opposite ends of the framework. The first hitch is pivotal relative to the second hitch. At least a portion of the first hitch is adjustable along the longitudinal length of the framework. At least a portion of the second hitch is adjustable along a longitudinal length of the framework.

In one embodiment, the first hitch includes first and second plates offset from, and generally parallel to, each other. At least one of the plates is adjustable along a longitudinal length of the framework.

In one embodiment, the first plate is wider than the second plate. The second plate is located near an end of the framework and the first plate is located between the second plate and a midpoint of the framework. The first plate is adjustable along the longitudinal length of the framework.

In one embodiment, the first hitch includes a pin adapted to be received in a pinhole of a wheeled cart. In one embodiment, the second hitch also includes a pin adapted to be received in a pinhole of another wheeled cart.

In one embodiment, the travel surface contacting assembly comprises a roller element. In one embodiment, the roller element is a wheel pivotally mounted on an axle. The biasing element is coupled at a first end with the framework and at a second end with the travel surface contacting assembly at a point near to, or on, the axle. In one embodiment, the travel surface contacting assembly further comprises a pivot arm comprising a first end pivotally coupled with the framework and a second end coupled with the roller element.

In one embodiment, the framework further comprises a plate portion extending between the first and second hitches and an elongated member perpendicularly extending from the plate portion. A first end of the biasing element is coupled with the elongated member and a second end of the biasing element is coupled to the travel surface contacting assembly. The elongated member includes a handle. The plate portion comprises a first section and a second section pivotally coupled to the first section.

The features, utilities, and advantages of various embodiments of the invention will be apparent from the following more particular description of embodiments of the invention as illustrated in the accompanying drawings and defined in the appended claims.

### BRIEF DESCRIPTION OF THE DRAWINGS

FIG. 1 is a side elevation view of the dual hitch assembly being used to couple together a pair of wheeled carts, which are then pulled along a surface in a train-like fashion by a powered pulling machine.

FIG. 2 is a top plan view of the arrangement depicted in FIG. 1.

FIG. 3 is an isometric view of the dual hitch assembly.

FIG. 4 is the same view of the dual hitch assembly, except the hitch assembly is shown exploded to better illustrate its components.

FIG. 5 is a side elevation of the dual hitch assembly.

FIG. 6 is top plan view of the dual hitch assembly.

FIG. 7 is an end elevation of the dual hitch assembly.

FIG. 8 is an isometric view the first hitch of the dual hitch assembly coupled to a cart.

FIG. 9 is an isometric view of an alternative hitch configuration wherein the dual hitch assembly utilizes hitch pins in place of the jaw-like hitches depicted in FIGS. 1-8.

FIG. 10 is an isometric view of another alternative hitch configuration wherein the dual hitch assembly utilizes hitch pins or pegs in place of the jaw-like hitches depicted in FIGS. 1-8.

### DETAILED DESCRIPTION OF THE INVENTION

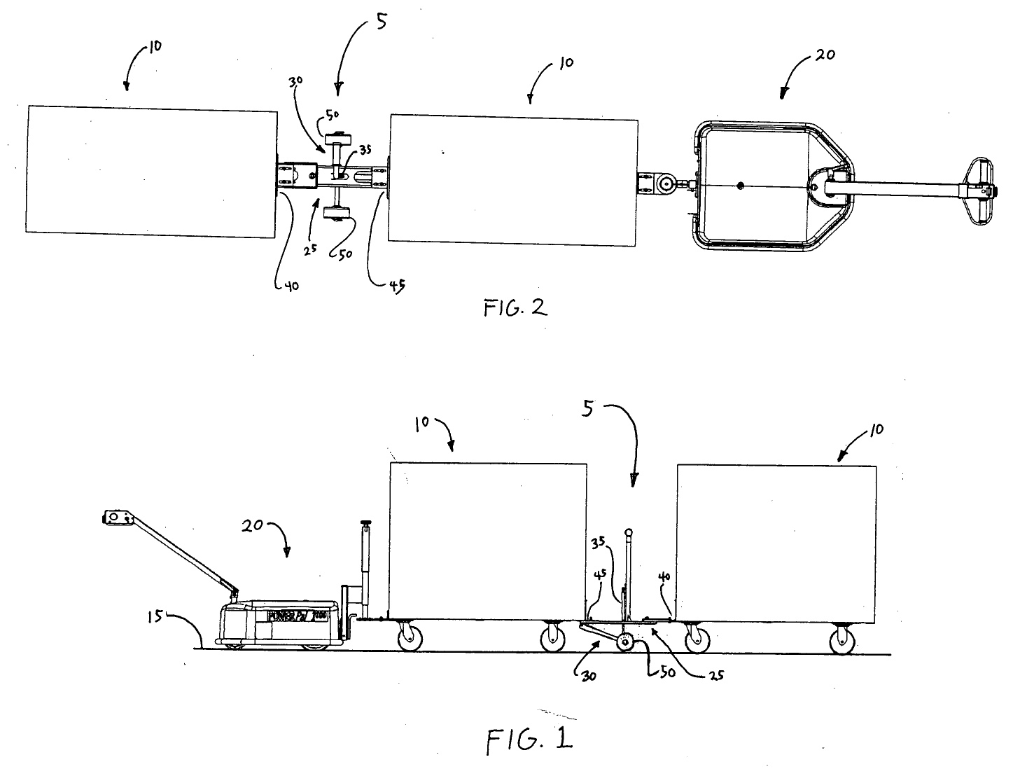

The present invention, in one embodiment, is a dual hitch assembly 5 for coupling together wheeled carts 10 that do not offer their own means of being coupled together, either because one or more of the carts 10 lack their own hitching mechanism or because the carts' hitching mechanisms are not compatible with each other. FIGS. 1 and 2 are, respectively, a side elevation view and a top plan view of the dual hitch assembly 5 being used to couple together a pair of wheeled carts 10, which are then pulled along a travel surface 15 in a train-like fashion by a powered pulling machine 20. As can be understood from FIGS. 1 and 2, the dual hitch assembly 5 of the present invention is advantageous in that it allows multiple wheeled carts 10 to be moved at one time via a powered pulling machine 20 when the carts 10, without the dual hitch assembly 5, would otherwise have to be moved individually with the machine 20. Thus, the dual hitch assembly 5 makes it possible to safely and efficiently move the wheeled carts 10.

As can be understood from FIGS. 1 and 2, the dual hitch assembly 5 includes a framework 25, a travel surface contacting assembly 30 and a biasing element 35. First and second jaw-like hitches 40, 45 are mounted on opposite ends of the framework 25. Each jaw-like hitch 40, 45 is adapted to engage a structural feature of its respective wheeled cart 10. The travel surface contacting assembly 30 includes a pair of wheels 50, which roll along the travel surface 15 when the hitch assembly 5 is engaged with the carts 10 via the hitches 40, 45. The biasing element 35 extends between the framework 25 and the travel surface contacting assembly 30, thereby biasing the framework 25 upward from the travel surface contacting assembly 30 such that the hitches 40, 45 are forced into, and maintained in, engagement with their respective carts 10.

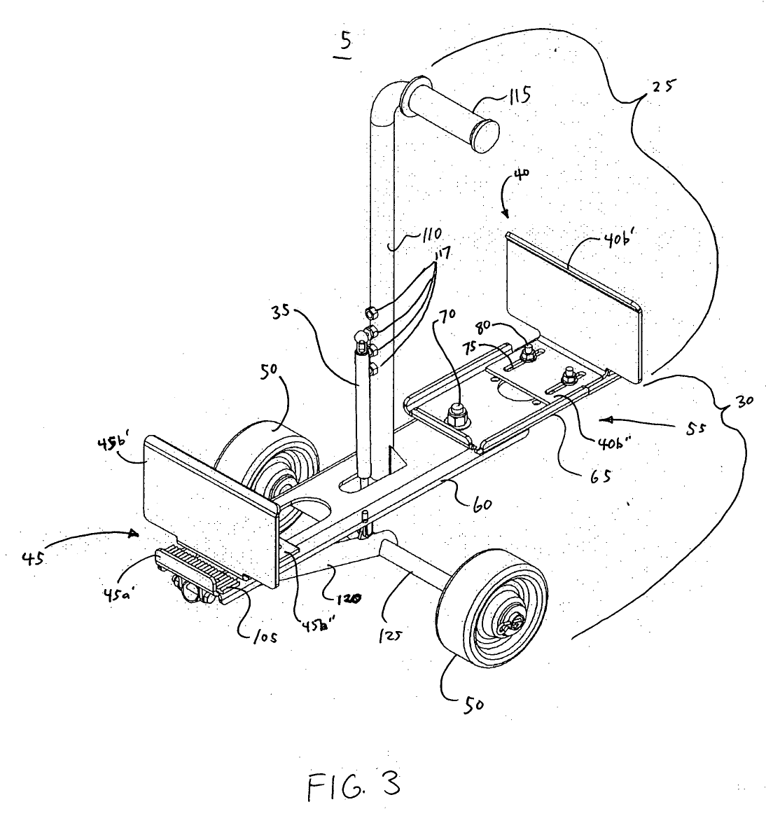

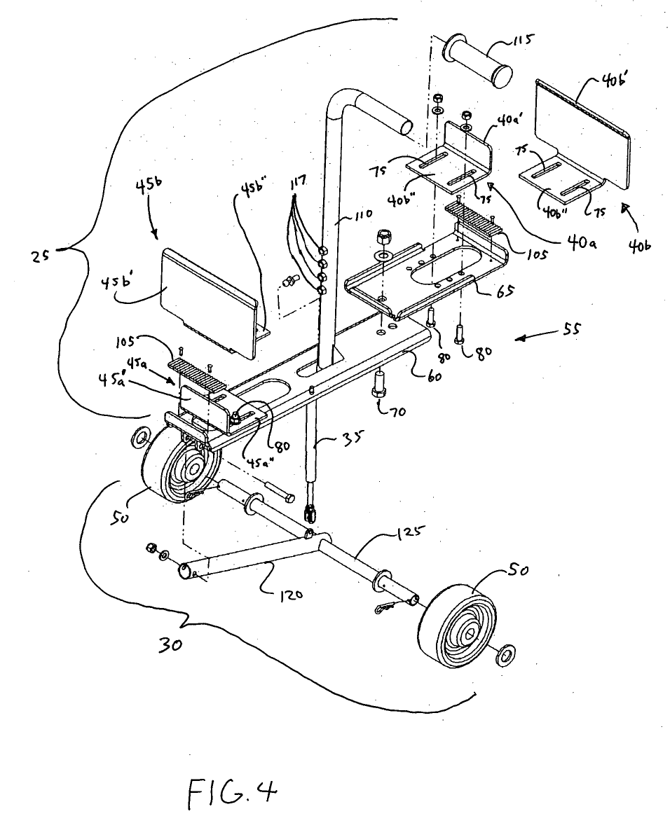

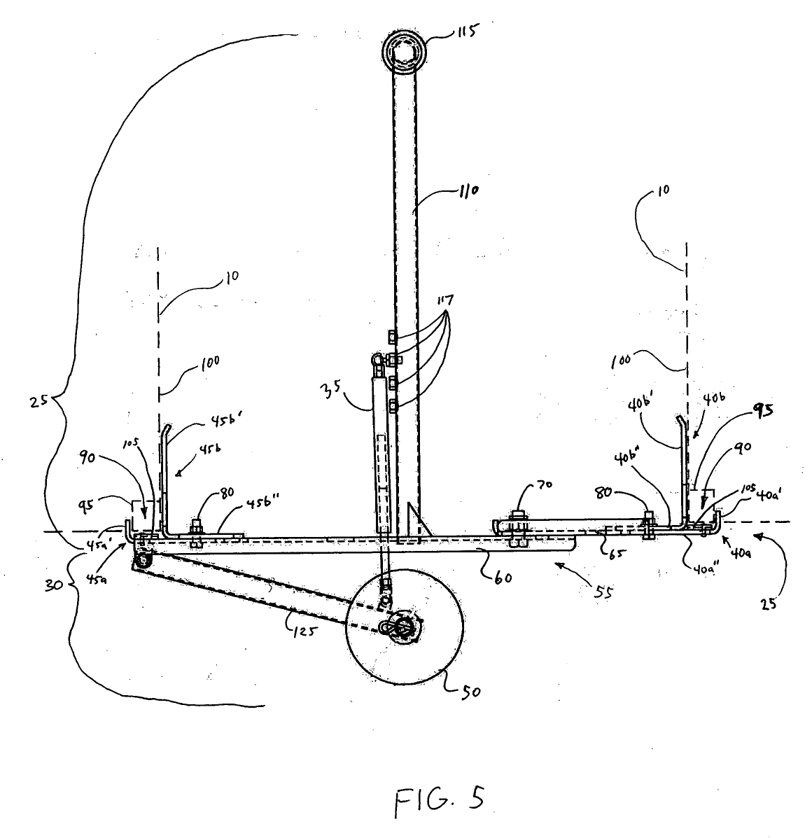

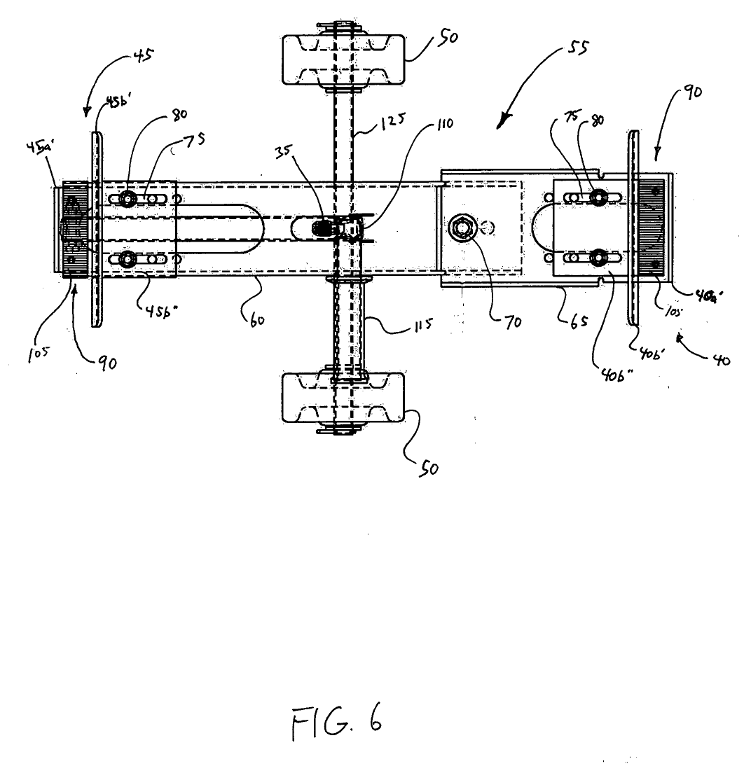

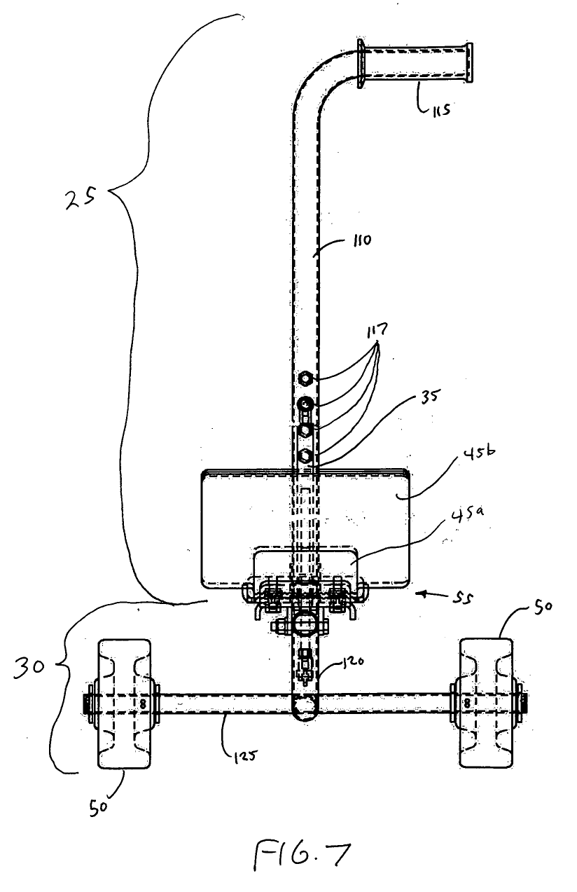

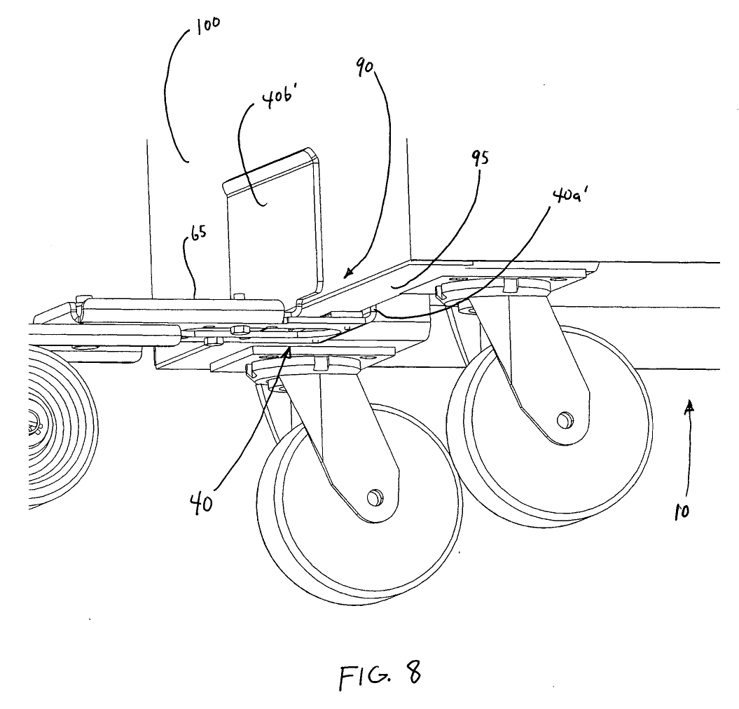

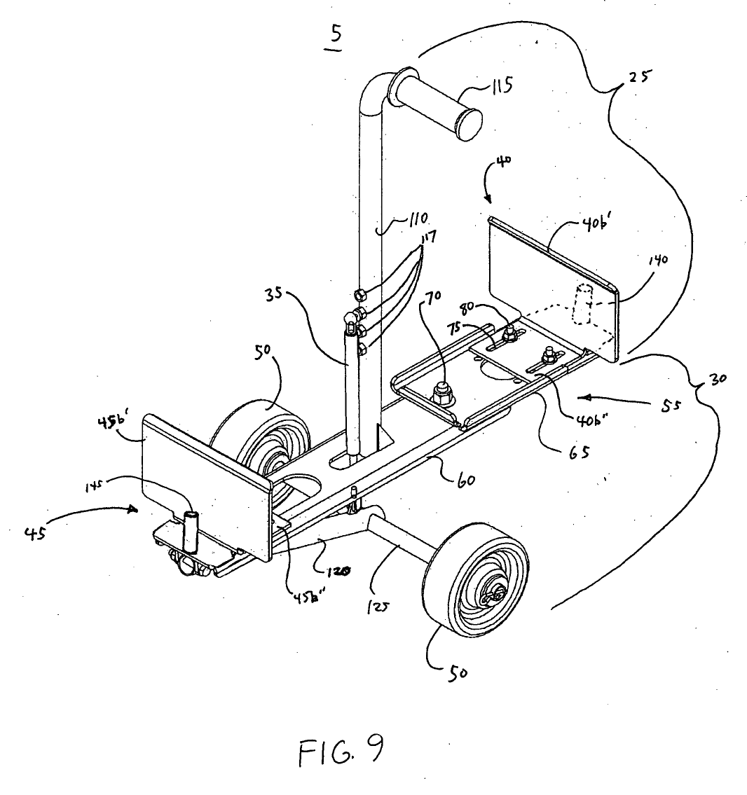

For a detailed discussion of the dual hitch assembly 5, reference is made to FIGS. 3-8. FIG. 3 is an isometric view of the hitch assembly 5. FIG. 4 is the same view of the dual hitch assembly 5, except the hitch assembly 5 is shown exploded to better illustrate its components. FIG. 5 is a side elevation of the dual hitch assembly 5 coupled to two wheeled carts 10, which are shown in phantom. FIG. 6 is top plan view of the dual hitch assembly. FIG. 7 is an end elevation of the dual hitch assembly 5.

As shown in FIGS. 3-7, in one embodiment, the framework 25 includes a horizontally extending portion 55 that includes a base plate 60 and a pivot plate 65. The pivot plate 65 comprises approximately one third of the longitudinal length of the horizontally extending portion 55 and includes the first hitch 40. The base plate 60 comprises approximately two thirds of the longitudinal length of the horizontally extending portion 55 and includes the second hitch 45. The pivot plate 65 is pivotally coupled on top of the base plate 60 via a bolt 70 at the end of the base plate 60 opposite the end supporting the second hitch 45. As can be understood from FIG. 2, this allows the pivot plate 65 to pivot relative to the base plate 60, which allows the first and second hitches 40, 45 to pivot relative to each other as the carts 10 travel around a corner.

As indicated in FIGS. 3-7, in one embodiment, each hitch 40, 45 includes a lip bracket 40a, 45a paired with a back bracket 40b, 45b. Each lip bracket 40a, 45a and back bracket 40b, 45b includes a vertical planar portion 40a′, 40b′, 45a′, 45b′ that perpendicularly extends from a horizontal base portion 40a″, 40b″, 45a″, 45b″. Each horizontal base portion 40a″, 40b″, 45a″, 45b″ includes longitudinally extending slots 75 that receive bolts 80 extending through the base and pivot plates 60, 65. The slots 75 are used to adjustably mount the brackets 40a, 40b, 45a, 45b on their respective plates 60, 65. This allows each pair of brackets 40a, 40b, 45a, 45b to be longitudinally adjustable along the plates 60, 65 relative to each other. Each pair of brackets 40a, 40b, 45a, 45b is mounted on its plate 60, 65 such that the vertical planar portions 40a′, 40b′, 45a′, 45b′ are offset from each other, thereby forming an adjustable gap, groove or slot 90, which runs perpendicularly to the longitudinal length of the respective plate 60, 65. Each vertical planar portion 40a′, 40b′, 45a′, 45b extends perpendicularly upward from its plate 60, 65.

As can be understood from FIGS. 1, 2, 5 and 8, which is an isometric view the first hitch 40 coupled to a cart 10, the slot 90 is adapted to engage a structural feature (e.g., a structural tubing, angle, channel, etc.) 95 of a wheeled cart 10. When the hitch assembly 5 is used to couple two carts 10 together, the vertical planar portion 40a′, 45a′ of each lip bracket 40a, 45a abuts against a vertical planar surface of the structural feature 95 to resist the forces that try to separate the carts 10 from each other. The vertical planar portion 40b′, 45b′ of each back bracket 40b, 45b abuts against an outer vertical planar surface 100 of a cart 10 to resist the forces that try to decrease the distance between the carts 10. When slot 90 is appropriately sized such that the relatively large surface are of the back bracket vertical planar portions 40b′, 45b′ abuts the outer vertical planar surface and the lip bracket vertical planar portions 40a′, 45a′ abuts the vertical planar surface of the structural feature 95, said vertical planar portions 40a′, 40b′, 45a′, 45b′ serve to prevent the attached cart 10 from pivoting relative to the hitches 40, 45.

As illustrated in FIGS. 3-6, a pad 105 covers the bottom (i.e., horizontal) surface of each slot 90. The pad 105 is formed from generally resilient polymer materials such as rubber. The pad 105 serves as a means of increasing frictional contact between the slot 90 and the structural feature 95 of the cart 10 received within the slot 90. The pad 105 makes it less likely that the structural feature 95 will slide relative to the slot 90 when the hitching assembly 5 is coupled to the cart 10.

In one embodiment, as indicated in FIGS. 3-7, the vertical planar portion 40b′, 45b′ of each back bracket 40b, 45b is generally wider and taller than the vertical planar portion 40a′, 45a′ of each respective lip bracket 40a, 45a. The relatively large surface area of the back bracket vertical planar portions 40b′, 45b′ help to maintain the carts 10 properly oriented relative to the hitch assembly 5 when negotiating corners (i.e., said vertical planar portions 40b′, 45b′ assist in cart steering).

As shown in FIGS. 3-7, an elongated member 110 extends vertically upward from the base plate 60 at approximately the longitudinal and latitudinal midpoints of the horizontally extending portion 55. A handle 115 extends from the extreme upward end of the elongated member 110. The handle 115 is used to provide a means of holding, installing and removing the hitch assembly 5.

As illustrated in FIGS. 3-7, four attachment elements 117 are positioned along a vertical segment of the elongated member 110. In one embodiment, the attachment elements 117 are threaded female orifices. In other embodiments, the attachment elements 117 are snap-fit female orifices. In either case, the attachment elements 117 serve as attachment locations for coupling an upper end of the biasing element 35 to the elongated member 110.

As illustrated in FIGS. 3-7, the travel surface contacting assembly 30 includes a pair of wheels 50, a pivot arm 120 and an axle 125 for pivotally supporting the pair of wheels 50. The pivot arm 120 extends between the framework 25 and the axle 125. Specifically, an upper end of the pivot arm 120 is pivotally coupled to the base plate 60 near the base plate's hitch 45. The axle 125 is coupled to a lower end of the pivot arm 120.

As shown in FIGS. 3-5, the upper end of the biasing element 35 couples to the elongated member 110 of the framework 25 via one of the attachment elements 117, and the bottom end of the biasing element 35 is pivotally coupled to the pivot arm 120 near intersection of the axle 125 with the pivot arm 120.

As can be understood from FIG. 1, the biasing element 35 biases the bottom end of the pivot arm 120 away from the framework 25, thereby forcing the wheels 50 against the transport surface 15 and the hitches 40, 45 into engagement with the wheeled carts 10. In other words, the wheels 50 rollably displace along the transport surface 15 to serve as a base for resisting the force of the biasing element 35, which forces the hitches 40, 45 of the framework up into engagement with the carts 10.

As can be understood from FIGS. 1, 3 and 5, to allow the dual hitching assembly 5 to be used with carts 10 having a variety of hitching heights, the offset distance between the bottom surface of the framework 25 and the axle 125 may be increased or decreased depending on which attachment element 117 is utilized to connect the upper end of the biasing element 35 to the elongated member 110. For example, if the upper end of the biasing element 35 is coupled to one of the lower attachment elements 117, the offset distance between the bottom surface of the framework 25 and the axle 125 will be greater than if one of the upper attachment elements 117 is used.

In one embodiment, the biasing element 35 is a gas spring or shock having a four-inch stroke and 50 pounds of resistive force. In one embodiment, the biasing mechanism is a helical spring or a leaf spring.

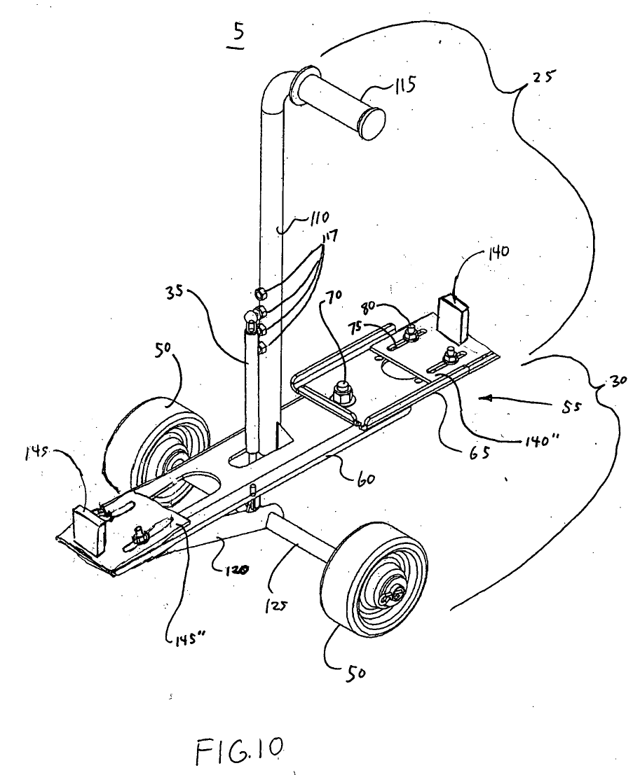

While FIGS. 1-8 depict a dual hitch assembly 5 that employs two jaw-like hitches 40, 45, those skilled in the art will understand that other types of hitches are readily applicable to the hitch assembly 5. For example, as indicated in FIG. 9, which is an isometric view of an alternative hitch configuration, the hitch assembly 5 can utilize hitch pegs or pins 140, 145 in place of the jaw-like hitches 40, 45 depicted in FIGS. 1-8. Each pin 140, 145 vertically extends from its respective plate 60, 65. The hitch pins 140, 145 are received in pinholes in a bottom surface of the carts 10. The same biasing force of the biasing element 35 maintains the hitch pins 140, 145 within the pinholes.

As shown in FIG. 9, in one embodiment where the pins 140, 145 are cylindrical, each pin 140, 145 is paired with, and offset from, a vertical planar portion 40b′, 45b′ of a back bracket 40b, 45b that is adjustably coupled to a plate 60, 65, as discussed above. This arrangement prevents the carts 10 from pivoting relative to their respective pins 140, 145.

As illustrated in FIG. 10, which is an isometric view of another alternative hitch configuration, the pegs or pins 140, 145 have square or rectangular cross-sections. Each peg or pin 140, 145 vertically extends from a horizontal base portion 140″, 145″, which is adjustably coupled to a plate 60, 65, as discussed above. The square or rectangular pins 140, 145 are received in similarly shaped pinholes or slots in a bottom surface of the carts 10. The mating of the faces of the pins 140, 145 with the faces of the pinholes prevents the carts 10 from pivoting about the pins 140, 145. Thus, unlike the preceding embodiment shown in FIG. 9, in the embodiment illustrated in FIG. 10, each pin 140, 145 does not need to be paired with a vertical planar portion 40b′, 45b′.

In use, as can be understood from FIG. 1, the dual hitch assembly 5 is placed on its wheels 50 between two adjacent wheeled carts 10. The handle 115 is gripped to tip the hitch assembly 5 about the wheels 50 such that the second hitch 45 is lowered below the structural feature 95 of a first cart 10. The handle 115 is tipped away from the first cart 10 about the wheels 50 such that the second hitch 45 is brought into hitching engagement with the structural feature 95 of the first cart 10. As the handle 115 is tipped away from the first cart 10 and the second hitch 45 increasingly engages the structural feature 95, the biasing element 35 compresses. This allows the wheels 50 and framework 25 move closer to each other as the pivot arm 120 pivots towards the framework 25. As a result, the first hitch 40 drops below the level of the structural feature 95 of the second cart 10. Once the first hitch 40 is positioned to engage the structural feature 95 of the second cart 10, the handle is released to allow the biasing element 35 to pivot the pivot arm 120 away from the framework 25, thereby causing the wheels 50 and framework 25 to diverge and the first hitch 40 to engage the structural feature 95 of the second cart 10 while the second hitch 45 remains engaged with the structural feature 95 of the first cart 10. Once the hitch assembly 5 has engaged both carts 10 in this manner, the powered pulling machine 20 is used to pull the two hitched carts 10 in a train-like fashion through the facility in a safe and efficient manner. To disengage the hitch assembly 5 from the carts 10, the preceding procedure is simply reversed.

While FIGS. 1 and 2 only depict a single pair of carts 10 being coupled together via the dual hitch assembly 5, those skilled in the art will readily understand that additional carts 10 could be added by using additional dual hitching assemblies 5. For example, by utilizing two dual hitch assemblies 5, three carts 10 could be pulled in a train-like fashion by a powered pulling machine 20. Similarly, by utilizing three or more dual hitch assemblies 5, four or more carts 10 could be pulled in a train-like fashion by a powered pulling machine 20.

Although various embodiments of this invention have been described above with a certain degree of particularity or with reference to one or more individual embodiments, those skilled in the art could make numerous alterations to the disclosed embodiments without departing from the spirit or scope of this invention. It is intended that all matter contained in the above description and shown in the accompanying drawings shall be interpreted as illustrative only of particular embodiments, and not limiting. Changes in detail or structure may be made without departing from the basic elements of the invention as defined in the following claims.

What is claimed is:

1. A hitch assembly comprising:
a framework comprising a first hitch and a second hitch;
a travel surface contacting assembly; and
a biasing element extending between the framework and the travel surface contacting assembly.

2. The hitch assembly of claim 1, wherein the hitches are at generally opposite ends of the framework.

3. The hitch assembly of claim 1, wherein the first hitch is pivotal relative to the second hitch.

4. The hitch assembly of claim 1, wherein at least a portion of the first hitch is adjustable along the longitudinal length of the framework.

5. The hitch assembly of claim 4, wherein at least a portion of the second hitch is adjustable along a longitudinal length of the framework.

6. The hitch assembly of claim 1, wherein the first hitch comprises first and second plates offset from, and generally parallel to, each other.

7. The hitch assembly of claim 6, wherein at least one of the plates is adjustable along a longitudinal length of the framework.

8. The hitch assembly of claim 6, wherein the first plate is wider than the second plate.

9. The hitch assembly of claim 8, wherein the second plate is located near an end of the framework and the first plate is located between the second plate and a midpoint of the framework.

10. The hitch assembly of claim 9, wherein the first plate is adjustable along the longitudinal length of the framework.

11. The hitch assembly of claim 1, wherein the first hitch comprises a pin.

12. The hitch assembly of claim 1, wherein the travel surface contacting assembly comprises a rolling element.

13. The hitch assembly of claim 12, wherein the rolling element is a wheel.

14. The hitch assembly of claim 13, wherein the travel surface contacting assembly further comprises an axle about which the wheel pivots, and the biasing element is coupled at a first end with the framework and at a second end with the travel surface contacting assembly at a point near to, or on, the axle.

15. The hitch assembly of claim 12, wherein the travel surface contacting assembly further comprises a pivot arm comprising a first end pivotally coupled with the framework and a second end coupled with the roller element.

16. The hitch assembly of claim 1, wherein the framework further comprises a plate portion extending between the first and second hitches and a shaft perpendicularly extending from the plate portion.

17. The hitch assembly of claim 16, wherein a first end of the biasing element is coupled with the shaft and a second end of the biasing element is coupled to the travel surface contacting assembly.

18. The hitch assembly of claim 16, wherein the shaft comprises a handle.

19. The hitch assembly of claim 16, wherein the plate portion comprises a first section and a second section pivotally coupled to the first section.

20. The hitch assembly of claim 1, wherein the biasing element is a gas shock.
